(19) United States
(12) Patent Application Publication
(10) Pub. No.: US 2005/0033613 A1
(43) Pub. Date: Feb. 10, 2005

(54) Reservation system

(75) Inventors: Pasquale A. Patullo, Hollywood, FL (US); Thomas L. Trotta, Cooper City, FL (US)

Correspondence Address: PATENT ADMINSTRATOR;KATTEN MUCHIN ZAVIS ROSENMAN, 525 WEST MONROE STREET, SUITE 1600, CHICAGO, IL, 60661-3693, US

(73) Assignee: VRL International c/o Ansbacher House

(21) Appl. No.: 09/828,437

(22) Filed: Apr. 6, 2001

(51) Int. Cl. G06F 17/60

(52) U.S. Cl. 705/5

(57) ABSTRACT

A reservation system for making travel arrangements via a computer network. The reservation system provides the user with a means for fast and efficient pricing of desired travel arrangements, and convenient booking of same.

### FIELD OF INVENTION

The present invention generally relates to a computer system for making travel arrangements, and more particularly to a computerized reservation system.

### BACKGROUND OF THE INVENTION

With the widespread use of public computer networks such as the Internet, there is a need to provide consumers and travel agents with more convenient, efficient and useful computer systems for making a wide range of travel arrangements via the computer network. Prior art computer systems have many drawbacks, including: requiring many manual steps (e.g., e-mail and/or phone calls) in the travel arrangement process, and requiring a user to make a financial payment or guarantee before reservations can be confirmed.

The present invention addresses these and other drawbacks of prior art computer systems for making travel arrangements.

### SUMMARY OF THE INVENTION

According to the present invention there is provided a reservation system for making travel arrangements.

An advantage of the present invention is the provision of a booking agent that provides improvements in ease of operation, flexibility, speed, and functionality.

Another advantage of the present invention is the provision of a booking agent that provides new and unique features for improved conveniences.

Still other advantages of the invention will become apparent to those skilled in the art upon a reading and understanding of the following detailed description, accompanying drawings and appended claims.

### BRIEF DESCRIPTION OF THE DRAWINGS

The invention may take physical form in certain parts and arrangements of parts, a preferred embodiment and method of which will be described in detail in this specification and illustrated in the accompanying drawings which form a part hereof, and wherein:

FIG. 1 is a general flow diagram illustrating operation of a reservation system according to a preferred embodiment of the present invention;

FIG. 2 provides a summary of the information content associated with the reservation system;

FIG. 3 illustrates an exemplary rates and reservation inquiry display, according to a preferred embodiment of the present invention;

FIG. 4 illustrates an exemplary price quote request display, according to a preferred embodiment of the present invention;

FIG. 5 illustrates an exemplary price quote result display, according to a preferred embodiment of the present invention;

FIGS. 6A and 6B illustrate an exemplary reservation booking request display, according to a preferred embodiment of the present invention;

FIG. 7 illustrates an exemplary reservation booking confirmation display, according to a preferred embodiment of the present invention;

FIGS. 8A and 8B illustrates detailed accommodations displays, according to a preferred embodiment of the present invention;

FIG. 9 illustrates another exemplary price quote result display, according to a preferred embodiment of the present invention;

FIG. 10 illustrates another exemplary reservation booking request display, according to a preferred embodiment of the present invention;

FIG. 11 illustrates exemplary coded airline reservation information;

FIG. 12 illustrates a general hardware arrangement, according to a preferred embodiment of the present invention; and

FIG. 13 illustrates data flow between hardware of the present invention.

### DETAILED DESCRIPTION OF THE PREFERRED EMBODIMENT`

It should be understood that while a preferred embodiment of the present invention is described herein in connection with making travel arrangements for a resort and airline flights, the present invention is not intended to be limited to same. In this regard, it is contemplated that the present invention is suitably used in connection with other types of travel arrangements, including but not limited to hotels/motels, condominium and vacation home rentals, cruise ships, train travel, car rental, and other forms of accommodations and transportation.

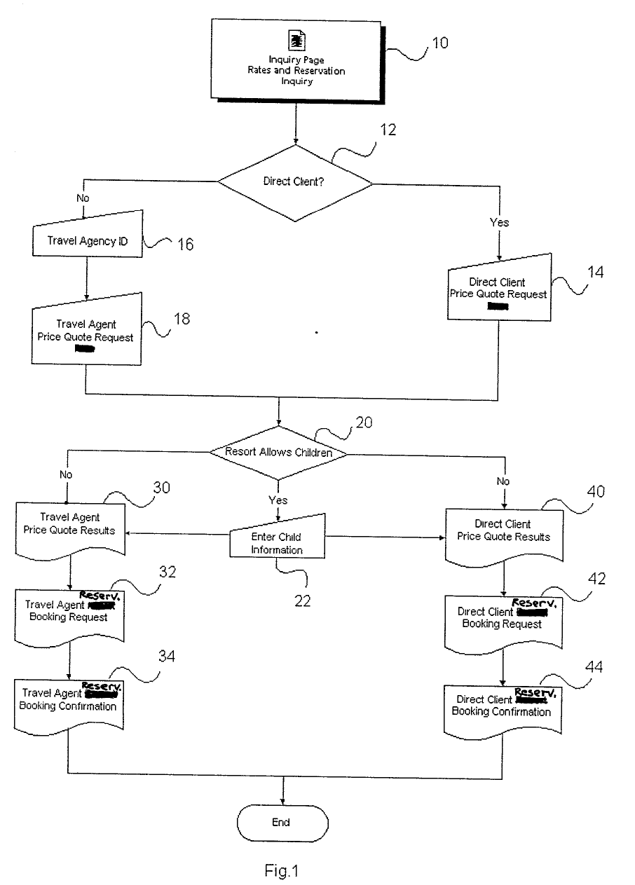

Referring now to the drawings wherein the showings are for the purposes of illustrating a preferred embodiment of the invention only and not for purposes of limiting same, FIG. 1 shows a general flow diagram illustrating operation of a reservation system (also known as a “booking engine”) according to a preferred embodiment of the present invention. First, a rates and reservation inquiry display is presented to a user (step 10). The user indicates whether they are a direct customer or a travel agency (step 12). If the user is a travel agency, a travel agency ID is entered (step 16) and a travel agent price quote request display is presented to the user (step 18). Similarly, if the user is a direct client, then a direct client price quote request display is presented to the user (step 14). It is then determined whether a selected resort allows children (step 20). If so, the user is provided with a display to enter child information (e.g., age) in step 22. This child information may also be important to making flight arrangements in order to reserve a seat suitable for infants/toddlers. If no children are allowed at the selected resort, the reservation system proceeds to steps 30-34 for travel agents, and steps 40-44 for direct clients. At steps 30 and 40, the user is presented with a price quote result display, at steps 32 and 42, the user is presented with a reservation booking request display, and at steps 34 and 44 the user is presented with a reservation booking confirmation display 34.

The reservation system is adapted for use by consumers directly, travel agents on behalf of consumers (with commissions applied), by consumers who may choose a travel agency as its advocate (with commissions applied), and by consumers who may link through a travel supplier or marketing affiliate (with commissions or points applied).

It should be understood that in accordance with a preferred embodiment of the present invention, the displayed information (including pricing) presented to a user is generally the same regardless of whether they are a travel agency or direct customer. However, the reservation system will provide a commission to the travel agency for sales made by the travel agency. In contrast, no commission is provided to direct clients. It should be noted that unpaid travel agency reservation booking confirmations may include the agency commission and net amount due after commissions are deducted. Alternatively, the commissions may not be applied until the confirmed reservation is transmitted into another reservation system.

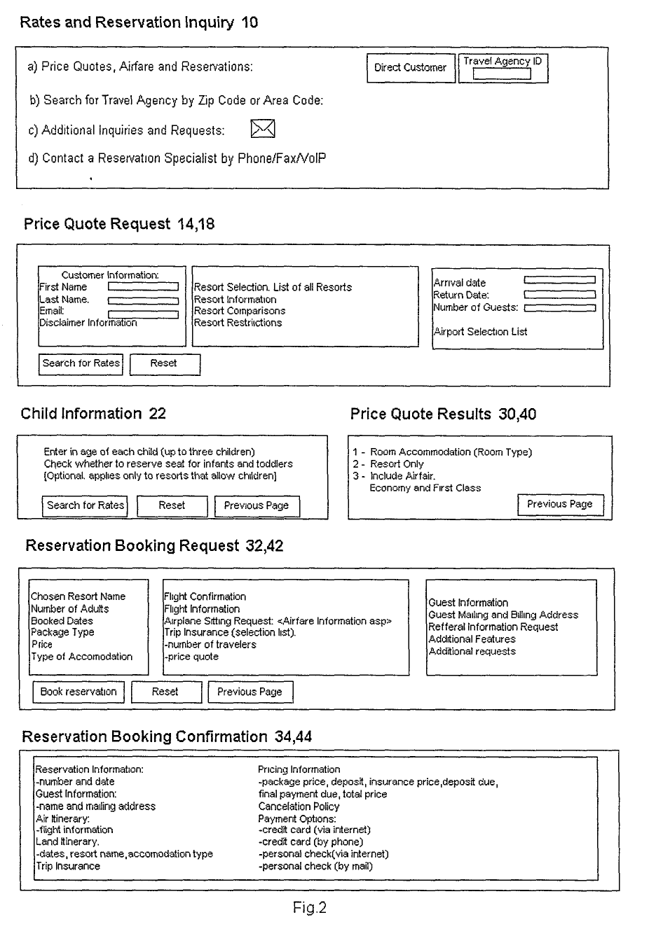

Referring now to FIG. 2, there is shown a summary of the information content associated with the rates and reservation inquiry display 10; price quote request display 14, 18; the child information display 22; the price quote results display 30, 40; the reservation booking request display 32, 42; and the reservation booking confirmation display 34, 44. Each of these displays presents the user with travel parameters associated with travel arrangements.

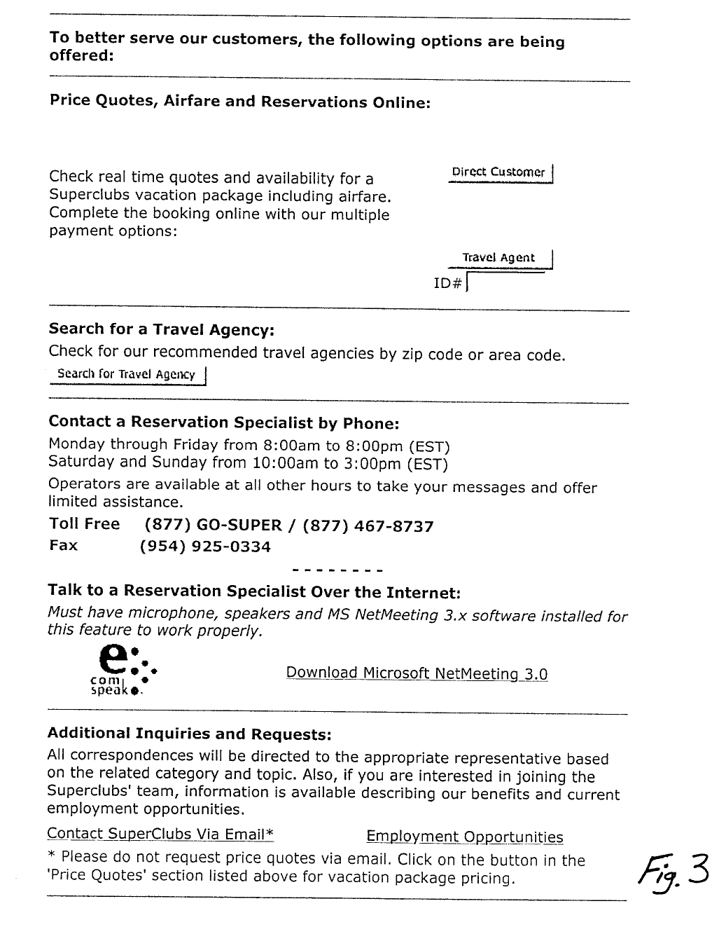

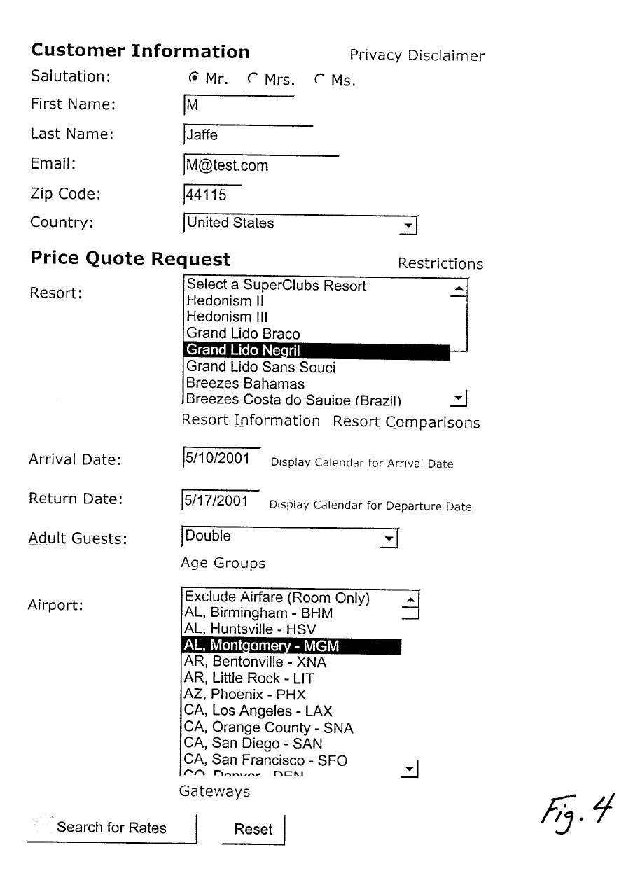

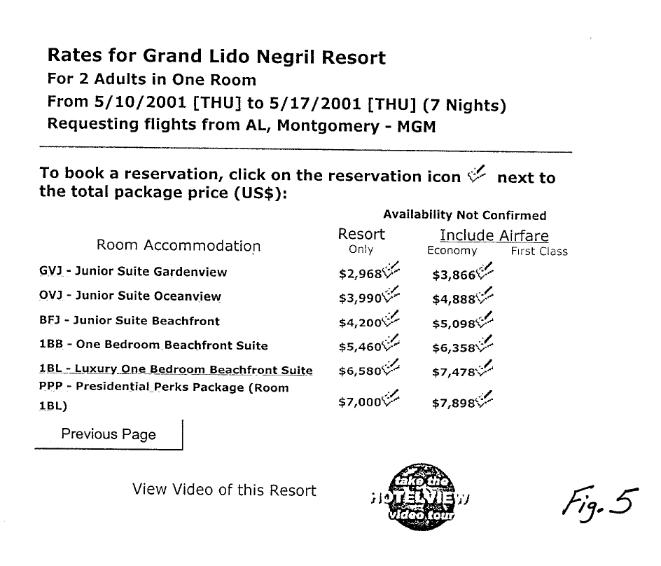

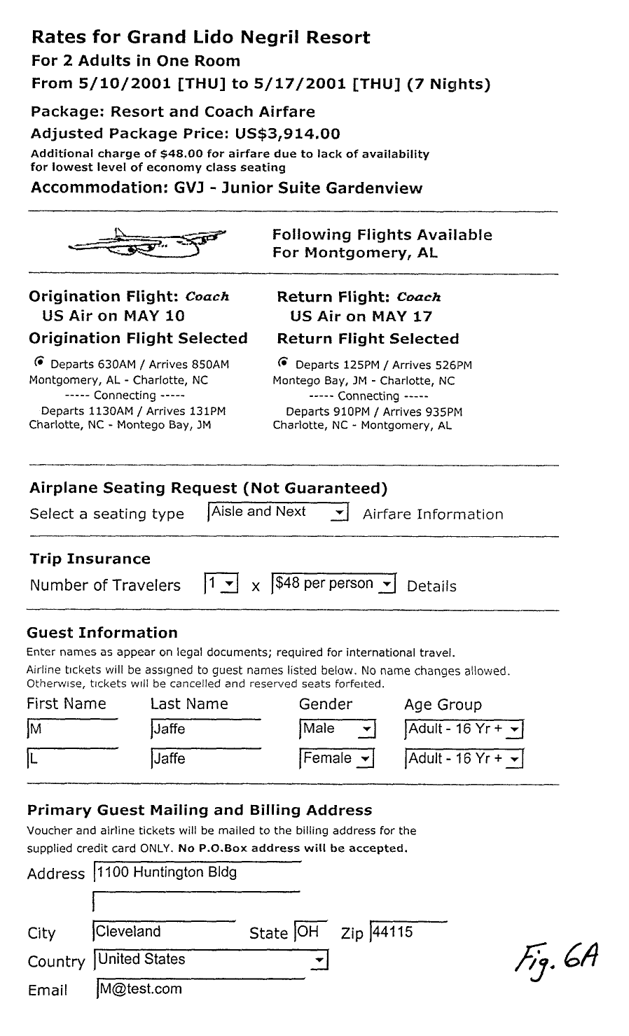

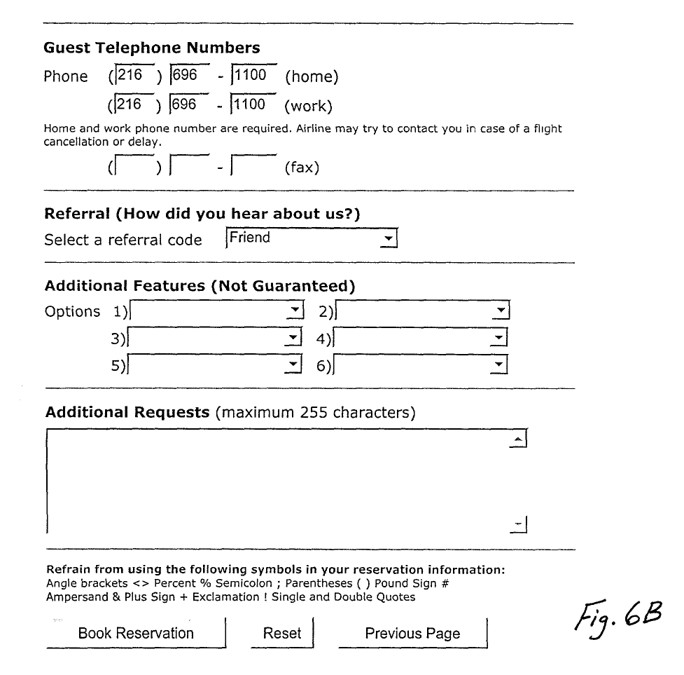

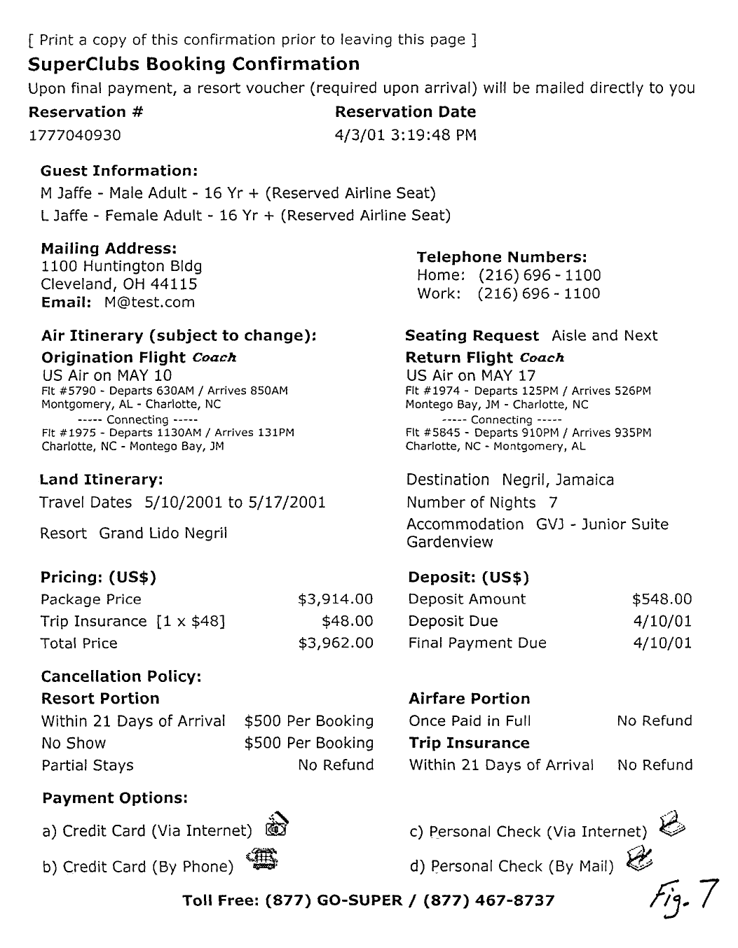

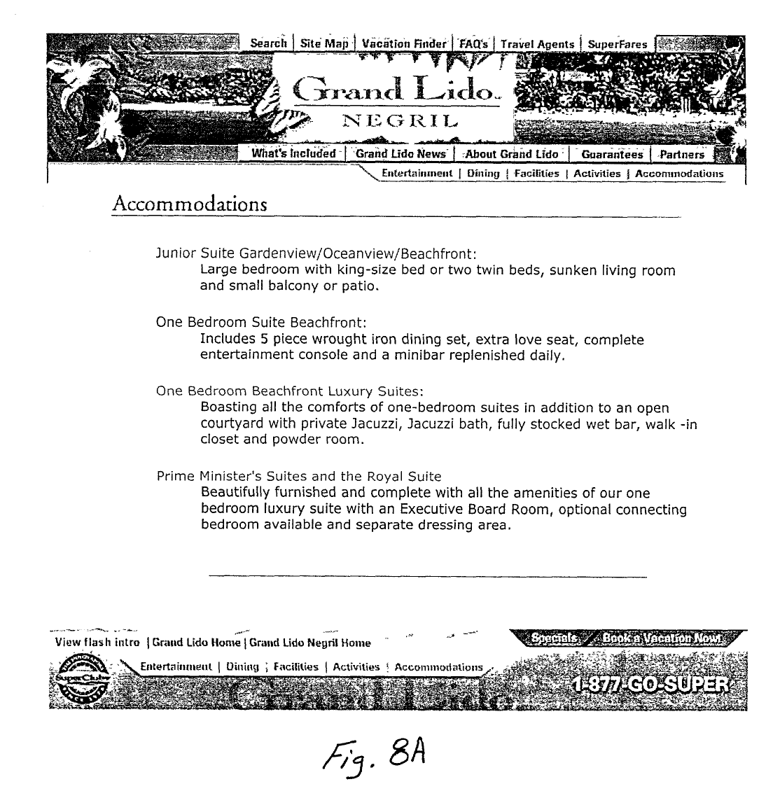

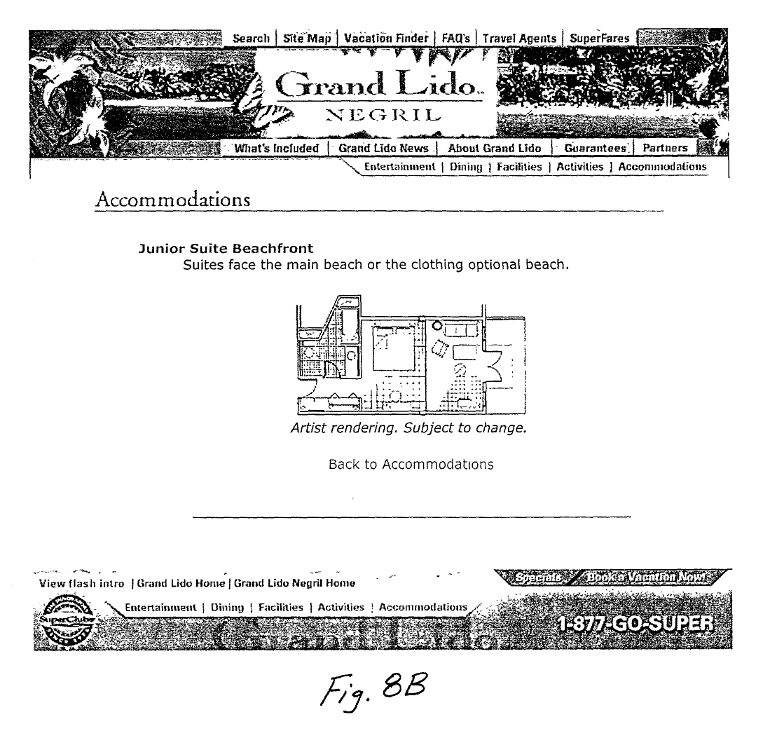

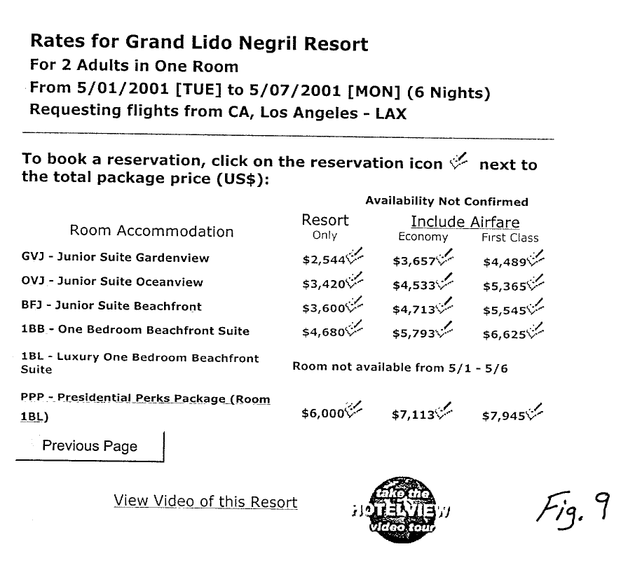

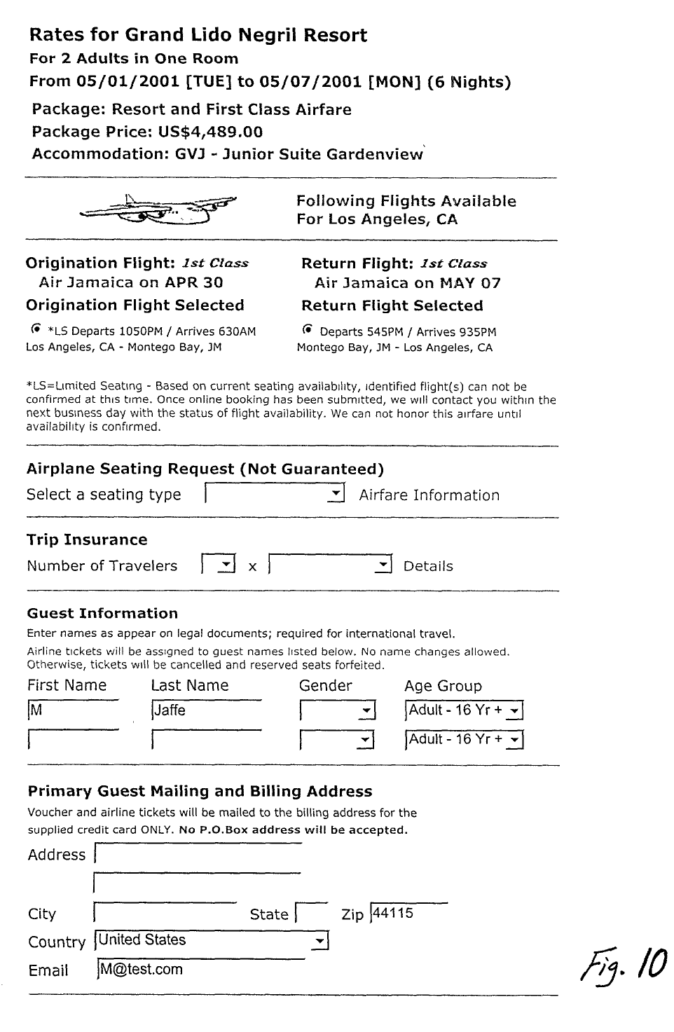

Detailed descriptions of the displays of the reservation system are provided below with reference to FIGS. 3-10. In particular, FIG. 3 illustrates an exemplary rates and reservation inquiry display; FIG. 4 illustrates an exemplary price quote request display; FIG. 5 illustrates an exemplary price quote result display; FIGS. 6A and 6B illustrate an exemplary reservation booking request display; FIG. 7 illustrates an exemplary reservation booking confirmation display; FIGS. 8A and 8B illustrates detailed accommodations displays; FIG. 9 illustrates another exemplary price quote result display; and FIG. 10 illustrates another exemplary reservation booking request display.

Referring now to FIG. 3, the exemplary rates and reservation inquiry display provides buttons for a user to select whether they are a direct client (direct customer) or a travel agent. If they are a travel agent, a travel agent ID is entered. In addition, a user may search for a recommended travel agency to assist them with their travel planning.

FIG. 4 shows a price quote request display, where customer information is entered (e.g., name, email, and address/location information) and a travel option is selected for a price quote request. Information associated with the travel option includes, but is not limited to, resort identifier, arrival date, return date, number of guests, and departure location (e.g., departure airport).

It should be appreciated that the price quote request display may present a user with a special option in the resort selection area of the display. For example, a user may select an accommodations package for an unknown resort (e.g., referred to as SuperSurprise). The user need only select a destination (e.g., by island, nation, continent, region, territory, kingdom, state, county, borough, province, parish, city, town, municipality, neighborhood, street, zip code, area code, country code) and a confirmed reservation will be made for only a group of resorts of a predetermined standard. The actual resort will be assigned by the reservation system or by some other means at a later date.

Upon entry of the information in the price quote request display, a price quote result display is generated (FIG. 5). This display provides a listing of room accommodations at the selected resort, pricing with resort only, and pricing with airfare (economy and/or first class). Moreover, this display also provides a summary of the basic selection information from the price quote request display, and allows a user to view images (e.g., a video) of the selected resort. Furthermore, this display may also informs the user of minimum night stay requirements and maximum adults per accommodation. It should be appreciated that in accordance with a preferred embodiment, the airfare pricing is determined by accessing a “local” database with prestored pricing information, rather than accessing an “outside” computer network, such as Sabre, Worldspan, or Amadeus for pricing information.

Upon displaying the selected room categories with total pricing (for dates and number of guests selected with and without airfare) a user may obtain additional accommodation information simply by clicking on the room category. This allows a customer who is unfamiliar with the resort to see the value and amenities they will receive, after knowing the price of the accommodation's package, but before making reservations. In this regard, FIGS. 8A and 8B illustrate exemplary displays of additional accommodation information. FIG. 8A provides a summary of the amenities of each type of accommodation, while FIG. 8B provides a room layout diagram of an accommodation selected in FIG. 8A. It should be appreciated that additional accommodation information may be presented to the user in other forms, such as images (e.g., still images, vidcaps, video), audio and multimedia.

It should be appreciated that after entry of the information associated with the price quote request display, the user is informed of the dates when a room category (or multiple categories) are unavailable for sale (FIG. 9). This allows a user to go back one step and easily select travel dates either before or after the unavailable period. This display of unavailable dates prevents a user from having to select date after date in a trial and error fashion to figure out when a desired room category is available for sale both before and after the original travel period requested. Multiple unsuccessful searches that do not aid the user towards a more informed subsequent search can frustrate the user and lead them to abandon the reservation process. FIG. 9 shows another exemplary price quote request display wherein economy and first class airfare is shown, and where room category unavailability is indicated for one type of room accommodation. Room category unavailability is indicated for all dates overlapping with selected dates from the price quote request display.

The “price matrix” (i.e., the resort and airfare prices for various room accommodations) presented in the price quote result display, is generated by checking resort availability, and then displaying real-time prices for those room nights, along with air prices that may be available on the travel dates selected. Air seat availability is not checked at this time. In this regard, it has been recognized that one of the most significant component of a (non-touring) leisure package is typically the resort. This is especially true for resorts that require multiple night stays and resorts that include, food, beverages, and activities bundled in their nightly prices. Since the air transportation is a secondary consideration, and a search for real-time flight availability information may require the accessing of an outside computer database, such as Sabre, Worldspan, and Amadeus (which can slow down the timely display of pricing information to the user), the data searching is limited to only select databases, which will be described below. As a result, a user will receive much faster response from the reservation system.

With reference to FIG. 5, an accommodations package with different amenities is displayed as a room category that does not exist at the resort (e.g., “Presidential Perks), with confirmed pricing and availability. If the user selects that accommodations package, the reservation system places the reservation in the proper hotel room category (e.g., penthouse suite), and provides a special pricing rate code instead of the normal rate for that room category.

It should be appreciated that the reservation system of the present invention provides enhanced convenience by providing a user with resort/air package pricing for multiple room categories and multiple air cabin classes on a single display screen (i.e., simultaneous display), after entry of the information in the price quote request display (FIG. 4).

Referring now to FIGS. 6A and 6B, there is shown an exemplary reservation booking request display. This display provides a summary of the basic selection information from the price quote request display; an adjusted package price, where any additional charges for airfare are necessary; the selected accommodation; and a listing of one or more available flights (which are selectable by the user). Moreover, the user is provided with a display for making an airplane seating request; for selecting trip insurance; for entering guest name/gender/sex information; for entering primary guest mailing and billing address information; for entering guest telephone numbers; for entering referral information; selecting additional features; and for making additional requests. It should be noted that the additional features requests refers to extra amenities and services, excursions, activities, and transportation. Transportation includes, but is not limited to: commuter air service, buses, cars, taxis, and rental cars.

The “additional features” section allows a user to select special features and room preferences from multiple drop-down boxes. The system places those requests inside the reservation and automatically passes this information to a tour operator, hotels, or other travel provider. As an example some of the options are: preference for a room on the ground floor, or far from the disco, etc . . .

The “additional requests” section allows a user to enter comments into a free form box, and pass any other information inside their reservation to a tour operator, hotel or other travel provider. For example, a user can specify a particular room number, that they be placed near another traveler also traveling at the same time, that they wish their refrigerator stocked with a certain beverage, that a special coupon should be applied as a discount or payment on their reservation, etc.

As indicated above, availability of airline flights is not checked at the time the user is presented with the price quote request result display. However, airline flight availability is checked prior to display of the reservation booking request (FIGS. 6A and 6B). Once flight availability is checked, all flight options available for each leg of the trip (direct and multi-segment) are displayed in the following manner: the reservation system displays each flight's availability in the cheapest category available to the reservation system, wherein if the lowest available fare is different (higher or lower) than the probable fare previously displayed to the user in the price quote result display, the fare difference is indicated, along with an adjusted package price.

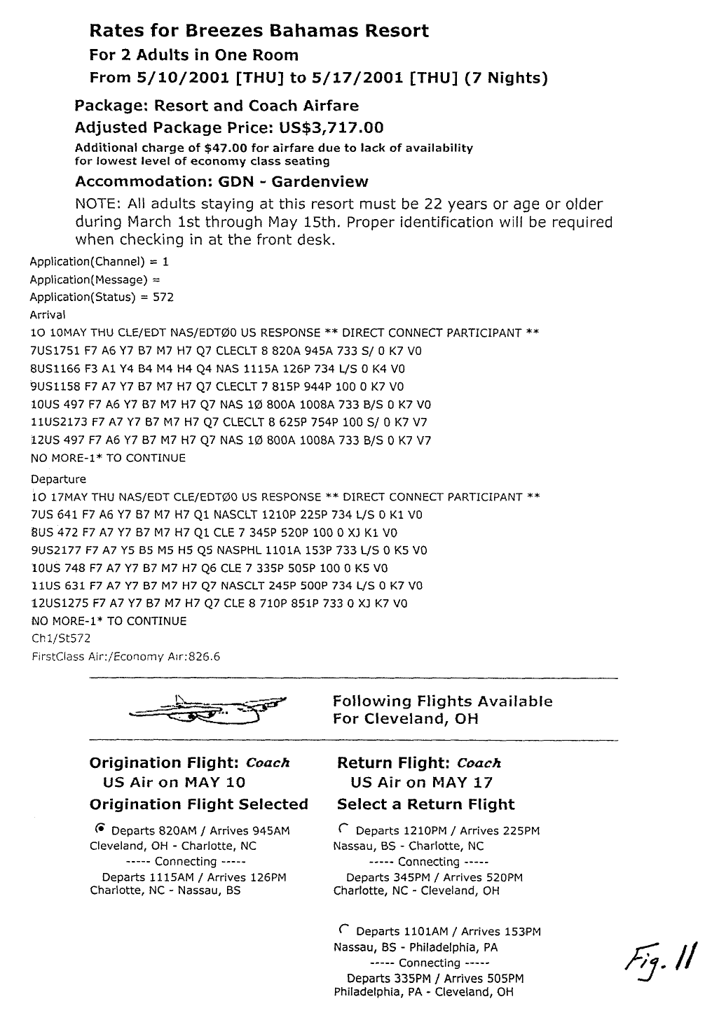

In accordance with a preferred embodiment, airline flight availability is checked by accessing an outside computer network, such as Sabre. The data received from the outside computer network may be encoded. For example, encoded flight data from Sabre is shown in FIG. 11. Accordingly, the present invention includes a decoding system for converting the encoded flight data into a readily readable format, as shown at the bottom of FIG. 11. The present invention also preferably include an encoding system for transmitting encoded data to the outside computer network.

It should be appreciated that according to a preferred embodiment of the present invention, the resort arrival date information input by the user is used by the reservation system to automatically adjust the date of the airline flight if the flight time extends over midnight or the flight extends across the international date line. This is applicable on both arrival and departure flights. For instance, if a guest desires to arrive in Jamaica on the morning of April 20^{th} and they are flying from California and the flight leaves California before midnight, the reservation system will list the flight as departing on the night of April 19^{th} and build an airline itinerary properly so that the flight arrives on the date the guest will check into the resort. This prevents an obvious problem from occurring where the guest may not leave the origination location until the night they intended to arrive at the resort, and consequently miss a day of paid resort accommodations. The reservation system also prevents a guest from having to enter multiple dates and perform multiple searches for the most convenient and economical flights arriving and departing the resort's locale on the dates specified.

Also, flights that have limited seats available are identified and a footnote is displayed stating any policy matters. An example is shown in FIG. 10, where a limited seating (LS) situation exists with respect to the selected flight. It should be noted that actual flight numbers are presented to the user in the reservation booking confirmation display (FIG. 7).

Once the user has completed the information in the reservation booking request display, they may proceed to booking a reservation. In this regard, reservation booking confirmation display (FIG. 7) is presented to the user. This display includes, but is not limited to, a reservation number; a reservation date; guest information; a mailing address; telephone numbers; the selected air itinerary (originating and return flights) and seating request; a land itinerary; pricing information; deposit information; and cancellation policy information. The user is also presented with a selection of payment options, including but not limited to: credit card via Internet (on-line real-time), credit card via phone, credit card via fax, personal check via Internet, electronic funds transfer (EFT) and personal check via mail.

It should be appreciated that in accordance with a preferred embodiment of the present invention, the reservation booking confirmation display presents the user with a resort's reservation number and/or a tour operator's reservation number. Furthermore, the reservation system may also automatically transfer a confirmed real time unpaid reservation into a tour operators reservation system, into a resort's property management system, into a hotel chain's central reservations system, and into a computer network that builds an airline flight ticket. Moreover, the reservation system may also automatically transfer an airline's ticket record locator number from a confirmed real time unpaid reservation and places it into a tour operators reservation system, into a hotel's property management system, and into a hotel chain's central reservations system.

The reservation system of the present invention allows a user to make both “confirmed” hotel/resort and airline reservations without requiring an upfront payment or guarantee. In this regard, the hotel/resort and airline reservations shown in the reservation booking confirmation display are confirmed, and payment may be made by the user at a later time.

It should be appreciated that further enhancements of the present invention are to automatically modify the displays presented to the user such that a distinctive “look and feel” (e.g., background color and style) is provided based upon a resort brand or specific resort selected. Another enhancement is for the reservation system to provide a logging procedure at each step in the reservation process for tracking statistical information (e.g., number of price quote requests, reservation requests and reservation submissions). The reservation system includes a reporting system for displaying statistics based on any and all information captured during the logging process.

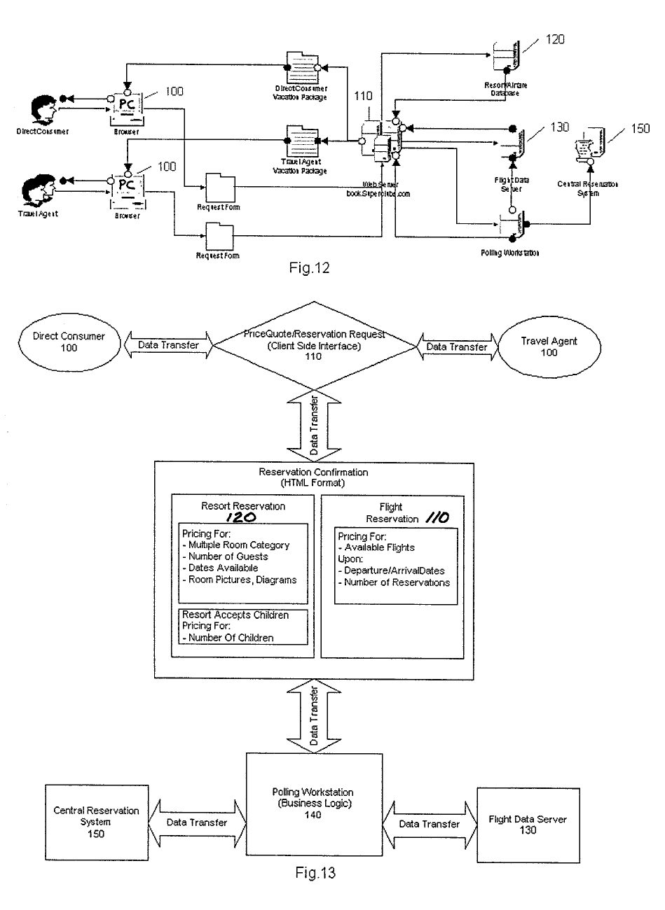

Referring now to FIG. 12, there is shown a general hardware arrangement of the reservation system, according to a preferred embodiment of the present invention. The hardware arrangement is generally comprised of one or more personal computers (PCs) 100, a web server 110, a resort/airfare database 120, a flight data server 130, a polling workstation 140 and a central reservation system 150. In accordance with a preferred embodiment of the present invention, PCs 100 run a browser program (e.g., Microsoft Internet Explorer or Netscape Navigator) to communicate with web server 110 via a computer network (e.g., the Internet). In turn, web server 110 communicates with resort/airfare database 120, flight data server 130, and polling workstation 140. Polling workstation 140 also communicates with central reservations system 150.

Resort/airfare database 120 stores several tables of data, including closeout information (e.g., resort name, accommodations, start and end date), gateway information (e.g., airport gateways), logging data (e.g., number of price quotes requested and number of reservations requested), referral information (e.g., how website found), additional or optional features information (e.g., request for accommodations near disco), airfare data, including, but not limited to: prestored airline (scheduled and charter) fares include published rates, bulk rates, bartered rates, contracted rates, sale rates, and travel agent rates, levies, fuel surcharges, and the like.

Resort/airfare database 120 also stores resort data, including, but not limited to: international rates, national rates, regional rates, vendor rates, EP rates, all-inclusive rates, special package and amenity rates, and length of stay rates. Also day rooms, day passes, and night passes may be priced. Accommodation categories are designated as either opened or closed for availability. Hotels, and cruise ships and their cabin categories can also be substituted for resorts and their room categories. Furthermore, a duplicate of the data stored in central reservation system is also stored in resort/airfare database 120.

Web server 110 acts as a central data hub. This server also decodes/encodes data transmitted/received to/from flight data server 130 (e.g., an outside computer network such as Sabre, WorldSpan or Amadeus).

Central reservation system 150 includes a travel agent database and reservation database. The travel agent database includes the travel agency identification numbers, address and contact information, the consortiums and group affiliations they belong to, their commission levels, bonus levels, point program levels, and passwords. Both land and air information is stored in the reservation database.

Polling workstation 140 polls for a text file from webserver 110. This text file will include information from reservation/airfare database 120. Information from the text file is then transferred to flight data server 130 (e.g., Sabre) and/or central reservation system 150.

FIG. 13 illustrates the flow of data between hardware of the present invention. In the case of a travel arrangement without air, data is transmitted between webserver 110 and reservation/airfare database 120, as reservation information is being entered by a user. Polling workstation 140 will poll webserver 110 for a text file which indicates that a reservation has been made by a user. The text file includes information that is transferred to central reservation system 150. A duplicate of the text file is stored at reservation/airfare database 120.

Where a travel arrangement includes air, data is transmitted between webserver 110 and reservation/airfare database 120, as reservation information is being entered by a user. Polling workstation 140 will poll webserver 110 for a text file indicative of a completed reservation. The text file includes information that is transferred to central reservation system 150. A duplicate of this text file is stored at reservation/airfare database 120. Furthermore, polling workstation 140 will poll webserver 110 for another text file, indicative of an airfare reservation. This text file will be encoded and transferred to flight data server 130. A results file is created by polling workstation 140 to indicate status information associated with the airfare reservation.

The present invention has been described with reference to a preferred embodiment. Obviously, modifications and alterations will occur to others upon a reading and understanding of this specification. It is intended that all such modifications and alterations be included insofar as they come within the scope of the appended claims or the equivalents thereof.

1. A reservation system for making travel arrangements upon request by a user, the system comprising:
means for determining whether the user is a direct customer or a travel agent;
means for receiving travel parameters associated with a desired travel option;
means for generating a listing of one or more travel arrangements in accordance with the travel parameters, said listing including pricing information associated with each respective travel arrangement; and
means for displaying the listing of the one or more travel arrangements.

2. A reservation system according to claim 1, wherein said listing includes a plurality of room accommodations, pricing information for the plurality of room accommodations, and pricing information for the plurality of room accommodations with one or more categories of airfare.

3. A reservation system according to claim 2, wherein said reservation system includes means for displaying images associated with the plurality of room accommodations, in response to selection of said plurality of room accommodations.

4. A reservation system according to claim 1, wherein said travel parameters includes accommodation name, arrival date, departure date, departure location, and number of guests, and wherein said listing includes information relating to whether children are allowed at the named accommodation.

5. A reservation system according to claim 1, wherein said listing indicates unavailability information associated with the travel arrangement, said unavailability information including dates of unavailability.

6. A reservation system according to claim 2, wherein said pricing information associated with the one or more categories of airfare is provided without regard to availability of seating.

7. A reservation system according to claim 6, wherein said reservation system further includes:
means for accessing an associated computer network to determine the availability of seating, after selection of a listed travel arrangement.

8. A reservation system according to claim 7, wherein said reservation system includes means for displaying one or more flight options after the associated computer network is accessed.

9. A reservation system according to claim 8, wherein said displayed one or more flight options includes an indication of a limited flight availability.

10. A reservation system according to claim 8, wherein said reservation system includes means for displaying price information and adjusted price information associated with the travel arrangements.

11. A reservation system according to claim 3, wherein said travel parameters include departure date and departure location, wherein dates associated with the airfare are determined in accordance with the departure date and departure location.

12. A reservation system according to claim 11, wherein said reservation system includes means for generating a confirmed travel arrangement without receipt of payment for the travel arrangement, the confirmed travel arrangement including information relating to a net amount of money due from the user, wherein when the user is a travel agent, the net amount of money due is reduced by an amount of an agency commission.

13. A method for making travel arrangements upon request by a user of a computer network, the method comprising:
determining whether the user is a direct customer or a travel agent;
receiving travel parameters associated with a desired travel option;
generating a listing of one or more travel arrangements in accordance with the travel parameters, said listing including pricing information associated with each respective travel arrangement; and
displaying the listing of the one or more travel arrangements.

14. A method according to claim 13, wherein said listing includes a plurality of room accommodations, pricing information for the plurality of room accommodations, and pricing information for the plurality of room accommodations with one or more categories of airfare.

15. A method according to claim 14, wherein said method further comprises displaying images associated with the plurality of room accommodations, in response to selection of said plurality of room accommodations.

16. A method according to claim 13, wherein said travel parameters includes accommodation name, arrival date, departure date, departure location, and number of guests and wherein said listing includes information relating to whether children are allowed at the named accommodation.

17. A method according to claim 13, wherein said listing indicates unavailability information associated with the travel arrangement, said unavailability information including dates of unavailability.

18. A method according to claim 14, wherein said pricing information associated with the one or more categories of airfare is provided without regard to availability of seating.

19. A method according to claim 18, wherein said method further comprises accessing an associated computer network to determine the availability of seating, after selection of a listed travel arrangement.

20. A method according to claim 19, wherein said method further comprises displaying one or more flight options after the associated computer network is accessed.

21. A method according to claim 20, wherein said displayed one or more flight options includes an indication of a limited flight availability.

22. A method according to claim 20, wherein said method further comprises displaying price information and adjusted price information associated with the travel arrangements.

23. A method according to claim 15, wherein said travel parameters include departure date and departure location, wherein dates associated with the airfare are determined in accordance with the departure date and departure location.

24. A method according to claim 23, wherein said method further comprises generating a confirmed travel arrangement without receipt of payment for the travel arrangement, the confirmed travel arrangement including information relating to a net amount of money due from the user, wherein when the user is a travel agent, the net amount of money due is reduced by an amount of an agency commission.

25. A reservation system for making travel arrangements upon request by a user, the system comprising:
a first data processing system for determining whether the user is a direct customer or a travel agent, receiving travel parameters associated with a desired travel option, generating a listing of one or more travel arrangements in accordance with the travel parameters, said listing including pricing information associated with each respective travel arrangement, and displaying the listing of the one or more travel arrangements; and
at least one database for storing a plurality of the travel arrangements and the associated pricing information.

26. A reservation system according to claim 25, wherein said reservation system further includes a polling computer for polling the first data processing system to transfer travel arrangement information to a second data processing system and a third data processing system.

27. A reservation system according to claim 26, wherein said second data processing system is a central reservation system, and said third data processing system is a flight data server.
